(19) United States
(12) Patent Application Publication
(10) Pub. No.: US 2024/0160068 A1
(43) Pub. Date: May 16, 2024

(54) DISPLAY DEVICE

(71) Applicant: InnoLux Corporation, Miao-Li County (TW)

(72) Inventors: Tsung-Han TSAI, Miao-Li County (TW); Chien-Hung CHEN, Miao-Li County (TW); Mei-Chun SHIH, Miao-Li County (TW)

(21) Appl. No.: 18/421,084

(22) Filed: Jan. 24, 2024

Related U.S. Application Data
(63) Continuation of application No. 17/366,441, filed on Jul. 2, 2021.
Application No. 17/366,441 is a continuation of application No. 16/351,758, filed on Mar. 13, 2019, now abandoned.
Application No. 16/351,758 is a continuation of application No. 15/272,833, filed on Sep. 22, 2016, now Pat. No. 10,274,800.

(30) Foreign Application Priority Data
Sep. 30, 2015 (CN) 201510638234.3

(51) Int. Cl. G02F 1/1362; G02F 1/1337; G02F 1/1343

(52) U.S. Cl. CPC G02F 1/136286; G02F 1/133707; G02F 1/134309; G02F 1/134336; G02F 1/134345; G02F 1/134363; G02F 1/134372; G02F 2201/121; G02F 2201/56

(57) ABSTRACT

A display device is provided. The display device includes a first electrode and a second electrode. The first electrode includes a first main portion, a first peripheral portion, and a plurality of first extending portions. Part of the first extending portions extend into the first peripheral portion and are connected to each other via a first vertically-extending portion. Other part of the first extending portions do not extend into the first peripheral portion and are separated from each other. The second electrode includes a second main portion, a second peripheral portion, and a plurality of second extending portions. Part of the second extending portions extend into the second peripheral portion and are connected to each other via a second vertically-extending portion. Other part of the second extending portions do not extend into the second peripheral portion and are separated from each other.

### CROSS REFERENCE TO RELATED APPLICATIONS

This application is a Continuation of U.S. patent application Ser. No. 17/366,441, filed on Jul. 2, 2021, and entitled “display device”, which is a Continuation of U.S. patent application Ser. No. 16/351,758, filed on Mar. 13, 2019, and entitled “display device”, which is a Continuation of U.S. patent application Ser. No. 15/272,833, filed on Sep. 22, 2016, and entitled “display device”, now U.S. Pat. No. 10,274,800 B2, which claims priority of China Patent Application No. 201510638234.3, filed on Sep. 30, 2015, the entirety of which is incorporated by reference herein.

### BACKGROUND OF THE INVENTION

### Field of the Invention

The present disclosure relates to a display device, and in particular to a display device with a disclination line.

### Description of the Related Art

Conventional display device includes a first substrate, a second substrate, a liquid-crystal layer, and an electrode. The liquid-crystal layer is disposed between the first substrate and the second substrate. The electrode is disposed on the first substrate. Conventionally, the electrode includes a plurality of branches, and corners are formed on the ends of the branches. Finding a way to improve the light transmittance and the response time is an important issue of the display technology.

### BRIEF SUMMARY OF THE INVENTION

In one embodiment, a display device is provided. The display device includes a first substrate, a second substrate, a liquid-crystal layer, a first electrode, and an opposite electrode. The liquid-crystal layer is disposed between the first substrate and the second substrate. The first electrode is disposed on the first substrate. The opposite electrode is disposed on the side of the second substrate that faces the first substrate. The first electrode comprises a first main portion and a plurality of first extending portions. The first extending portions are connected to the first main portion, and at least one of the first extending portions comprises a first side, a second side, and a curved side. The curved side connects the first side and the second side, and the curved side has a first curvature radius greater than zero.

In another embodiment, a display device is provided. The display device includes a first substrate, a second substrate, a liquid-crystal layer, a first electrode, and an opposite electrode. The liquid-crystal layer is disposed between the first substrate and the second substrate. The first electrode is disposed on the first substrate. The opposite electrode is disposed on the side of the second substrate that faces the first substrate. The first electrode comprises a first main portion and a plurality of first extending portions. The first extending portions are connected to the first main portion, and at least one of the first extending portions comprises a first side, a second side, and a curved side. The curved side connects the first side and the second side. The first side connects the first main portion at a first end point. The second side connects the first main portion at a second end point. The curved side connects the first side at a third end point. The curved side connects the second side at a fourth end point. The area of the first extending portion is greater than the quadrilateral area enclosed by the first, second, third, and fourth end points.

In another embodiment, a display device is provided. The display device includes a first substrate, a second substrate, a liquid-crystal layer, a first sub-pixel area, and a second sub-pixel area. The liquid-crystal layer is disposed between the first substrate and the second substrate. A disclination line structure is between the first sub-pixel area and the second sub-pixel area, and the disclination line structure comprises a disclination line main portion and a plurality of top indentations. A virtual line segment is defined at a location where one of the top indentations connect to the disclination line main portion. The virtual line segment is parallel to the extending direction of the disclination line main portion. The one of the top indentation comprises a first disclination line side and a second disclination line side. The first disclination line side is relatively adjacent to the center of the disclination line main portion. The second disclination line side is relatively away from the center of the disclination line main portion. A first included angle between the first disclination line side and the virtual line segment is greater than a second included angle between the second disclination line side and the virtual line segment, and the first included angle and the second included angle are inside the top indentation.

Utilizing the curved side mentioned above, the arrangement of the liquid-crystal molecules is improved, and the light transmittance and the response time response time are improved. Additionally, utilizing the disclination line structure of the embodiment, the retention time is decreased, and the visual angle is made uniform.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 is a cross sectional view of the display device of the embodiment;

FIG. 2A shows the main structure of the display device of the embodiment;

FIG. 2B is an enlarged view of portion 2B of FIG. 2A;

FIG. 3A shows the main structure of the display device of another embodiment;

FIG. 3B is an enlarged view of portion 3B of FIG. 3A;

FIG. 4A shows a disclination line structure of an embodiment;

FIG. 4B shows detailed structure of the disclination line structure of the embodiment;

FIG. 4C shows the disclination line structure corresponding to the display device;

FIG. 4D shows a display device of a modified embodiment;

FIG. 4E is an enlarged view of FIG. 4A;

FIG. 5A shows the main structure of the display device of yet another embodiment;

FIG. 5B is an enlarged view of portion 5B of FIG. 5A; and

FIG. 6 shows the main structure of the display device of another embodiment, wherein the display device is a close-type indium tin oxide electrode display device.

### DETAILED DESCRIPTION OF THE INVENTION

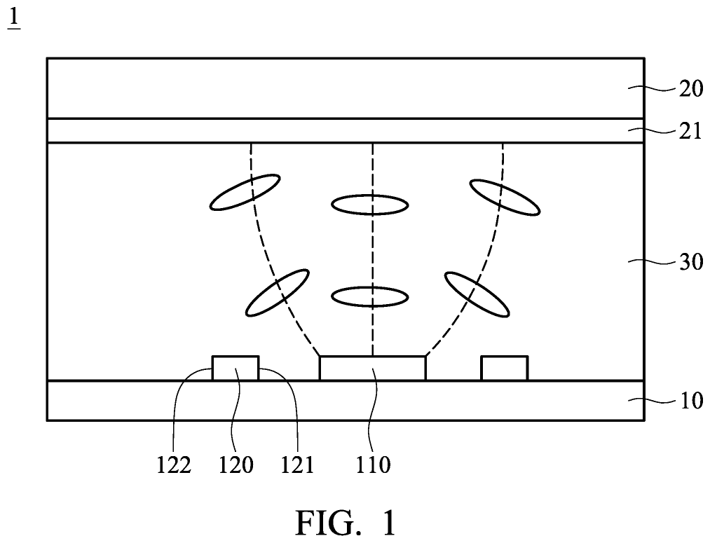

FIG. 1 shows a display device 1 of a first embodiment. The display device 1 includes a first substrate 10, a second substrate 20, a liquid-crystal layer 30, a first electrode 100, and an opposite electrode 21. The liquid-crystal layer 30 is disposed between the first substrate 10 and the second substrate 20. The first electrode 100 is disposed on the first substrate 10. The opposite electrode 21 is disposed on the side of the second substrate 20 that faces the first substrate 10. In more detail, the liquid-crystal layer 30 is disposed between the first electrode 100 and the opposite electrode 21.

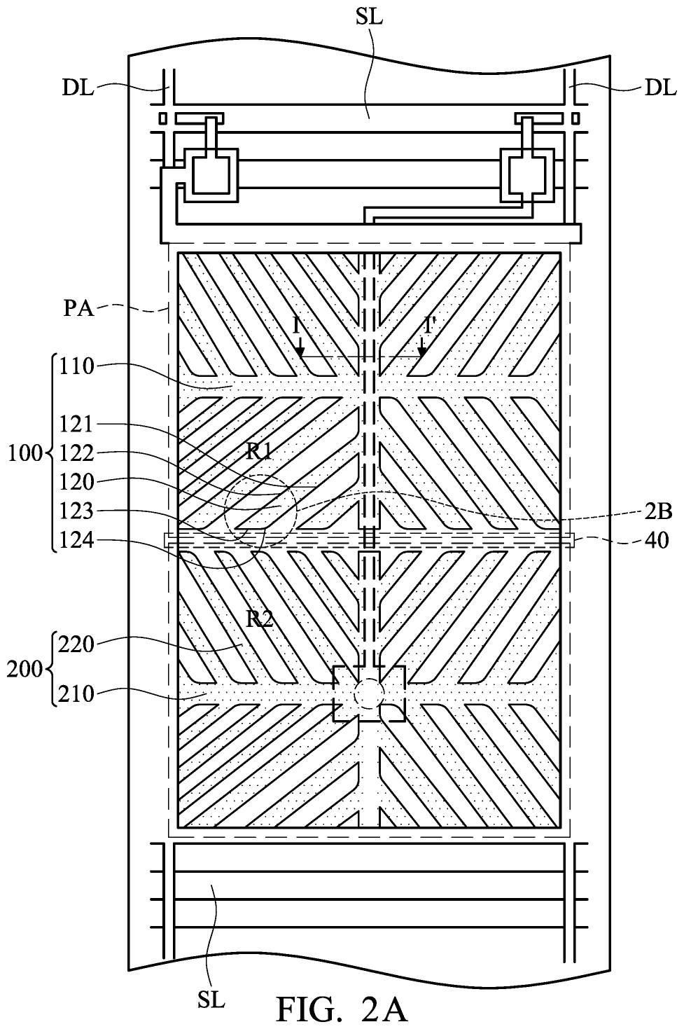

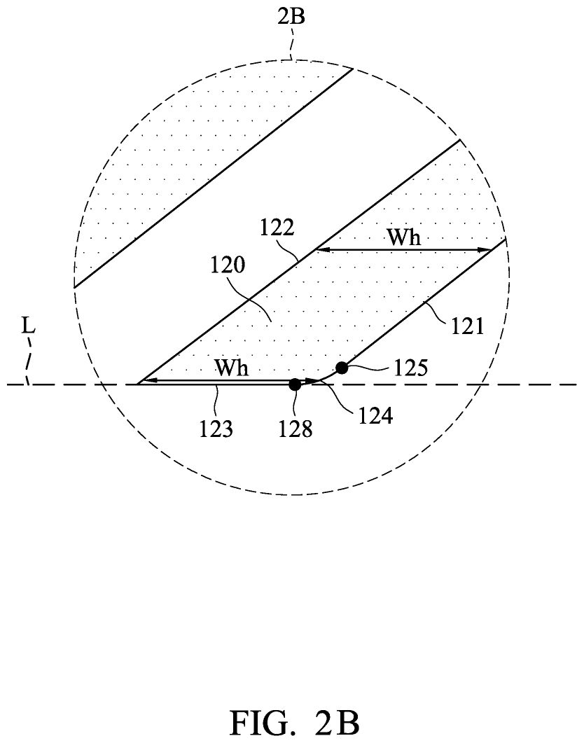

FIG. 2A shows the main structure of the display device 1. The first electrode 100 comprises a first main portion 110 and a plurality of first extending portions 120. The first extending portions 120 are connected to the first main portion 110. In one embodiment, the first main portion 110 is a cross-shaped electrode with horizontal axes and vertical axes. An included angle between the horizontal axes or the vertical axes of the first extending portions 120 and the first main portion 110 is between 10 degrees and 80 degrees. FIG. 1 is a cross sectional view along I-I′ direction of FIG. 2A. With reference to FIGS. 2A and 2B, at least one of the first extending portions 120 comprises a first side 121, a second side 122 and a curved side 123. At FIG. 1, a horizontal distance between the first side 121 and a point of the vertical axis of the first main portion 110 is shorter than a horizontal distance between the second side 122 and the point of the vertical axis of the first main portion 110. In another words, the first side 121 is relatively adjacent to the vertical axis of the first main portion 110. The second side 122 is relatively away from the vertical axis of the first main portion 110. The curved side 123 includes a first round corner 124. The first round corner 124 includes a first round corner end 125 connected to the first side 121. The first round corner 124 has a first curvature radius greater than zero. In one embodiment, the first curvature radius is smaller than or equal to 51 μm. In one embodiment, the first side 121 is parallel to the second side 122.

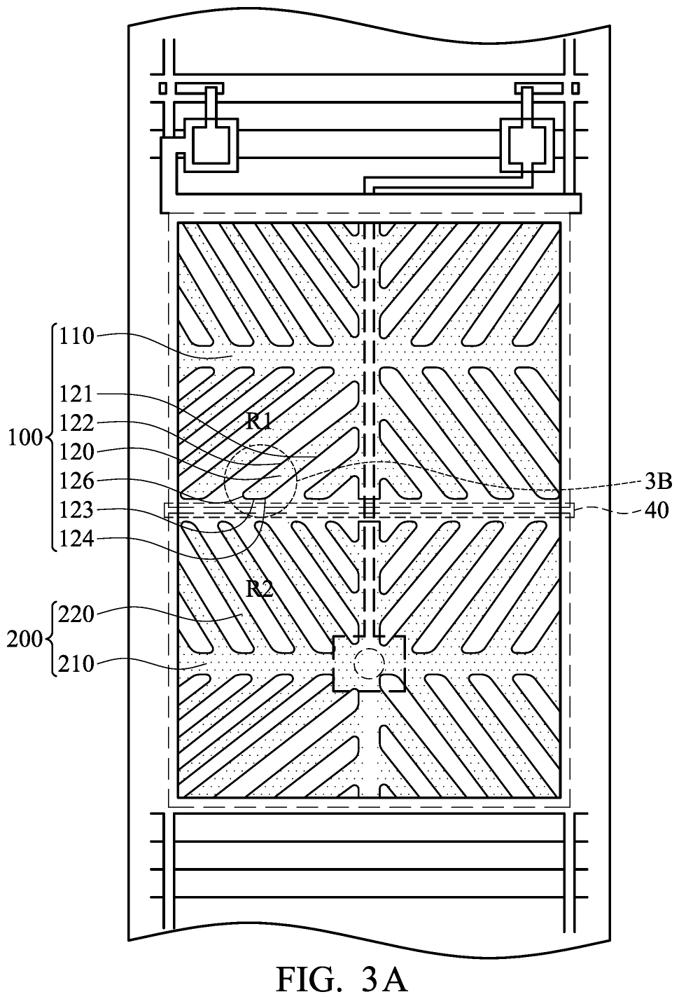

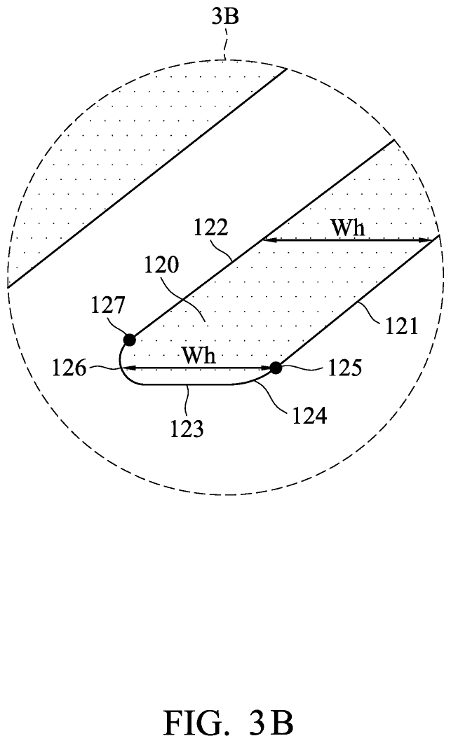

With reference to FIGS. 3A and 3B, in another embodiment, the curved side 123 has a second round corner 126. A third round corner end 127 of the second round corner 126 is connected to the second side 122. The second round corner 126 has a second curvature radius greater than zero. The first round corner 124 is located between the second round corner 126 and the first side 121. The second curvature radius is smaller than the first curvature radius.

With reference to FIG. 2A, the display device further comprises a first sub-pixel area R1 and a second sub-pixel area R2 adjacent to the first sub-pixel area R1. The first electrode 100 is disposed in the first sub-pixel area R1. The second electrode 200 is disposed on the first substrate 10 and located in the second sub-pixel area R2. The second electrode 200 comprises a second main portion 210 and a plurality of second extending portions 220, and the second extending portions 220 are connected to the second main portion 210. A common electrode 40 is disposed on the first substrate 10 and at least partial of the common electrode 40 located between the first sub-pixel area R1 and the second sub-pixel area R2. In one embodiment, the first extending portions 120 extend from the first main portion 110 toward the common electrode 40. An electrical potential (voltage) difference between the first electrode 100 and the second electrode 200 is greater than zero.

In more detail, the display device further comprises a plurality of scan lines SL and a plurality of data lines DL. With reference to FIGS. 2A and 2B, the two adjacent scan lines and the two adjacent data lines defined a pixel area PA, and at least partial of the first sub-pixel area R1 and the second sub-pixel area R2 are located in the pixel area PA.

With reference to FIGS. 2A and 2B, a virtual line L is parallel to the common electrode 40. A second round corner end 128 of the first round corner 124 is a tangent point of the curved side 123 and the virtual line L.

With reference to FIG. 2A, in one embodiment, the horizontal width Wh of a part of the first extending portions 120 relatively adjacent to the common electrode 40 is shorter than the horizontal width Wh of a part of the first extending portions 120 relatively adjacent to the first main portion 110. The horizontal width Wh is the line width parallel to the common electrode 40 or the scan line SL.

Utilizing the curved side mentioned above, the arrangement of the liquid-crystal molecules is improved, and the light transmittance and the response time are increased. When the first curvature radius is greater than zero and smaller than 10 μm, the light transmittance is increased under any driving voltage. In another embodiment, the first curvature radius could be smaller than 10 μm Additionally, the curved side of the embodiment is relatively retracted compared to the conventional structure. When the display device is recovered from being pressed (for example, by a finger) in a short period, the liquid-crystal molecules have greater space, and the liquid-crystal molecules return to their original positions rapidly, and the retention time is decreased. Similarly, the design of second round corner also improves retention time. However, when the first curvature radius is greater than 10 μm, the light transmittance may be decreased. Therefore, in another embodiment, the first curvature radius be greater than zero and smaller than or equal to 5 μm.

With reference to FIG. 2A, in one embodiment, a part of the first extending portions 120 and a part of the second extending portions 220 are staggered relative to common electrode 40. Specifically, the parts of the first extending portions 120 adjacent to the vertical axis of the first main portion 110 are arranged corresponding to the second extending portions 220 adjacent thereto. The parts of the first extending portions 120 away from the vertical axis of the first main portion 110 are staggered with the second extending portions 220 adjacent thereto, the first extending portions 120 and the second extending portions 220 are positioned at the opposite side of the common electrode 40. In other words, a part of the first extending portions 120 with relatively longer length are staggered with the second extending portion 220 adjacent thereto. In another embodiment, two of the first extending portions 120 with the longest length are staggered with the second extending portion 220 adjacent thereto.

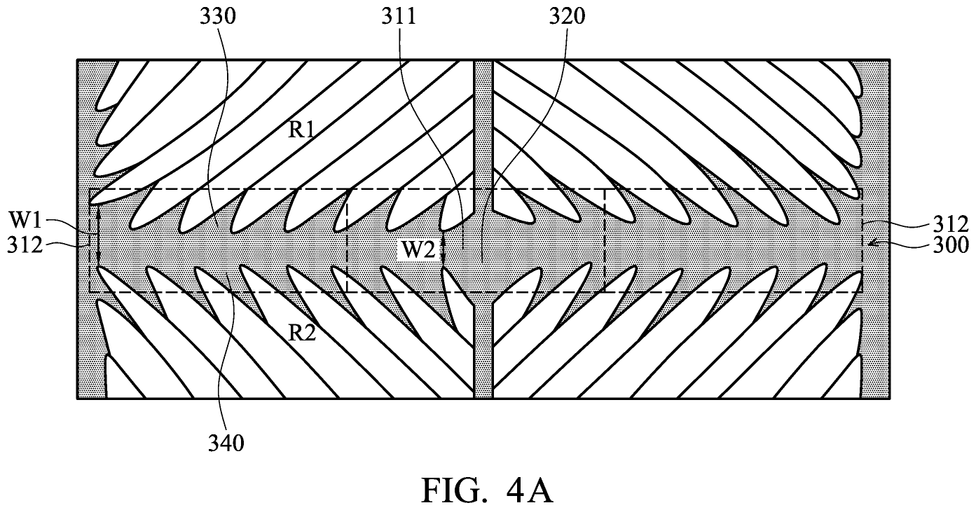

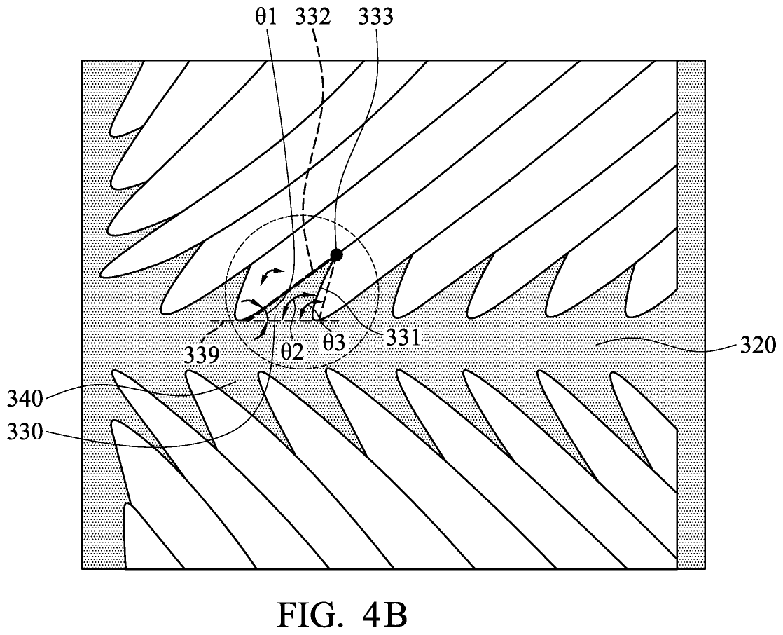

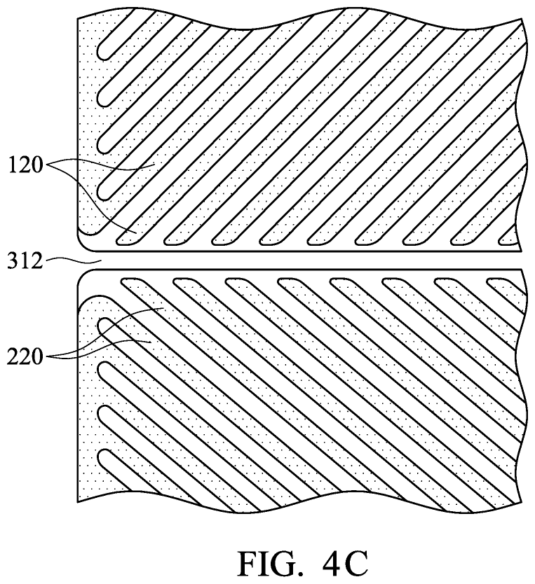

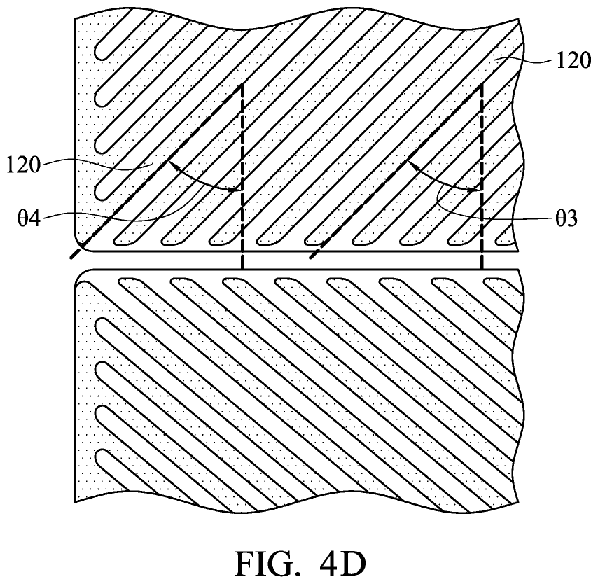

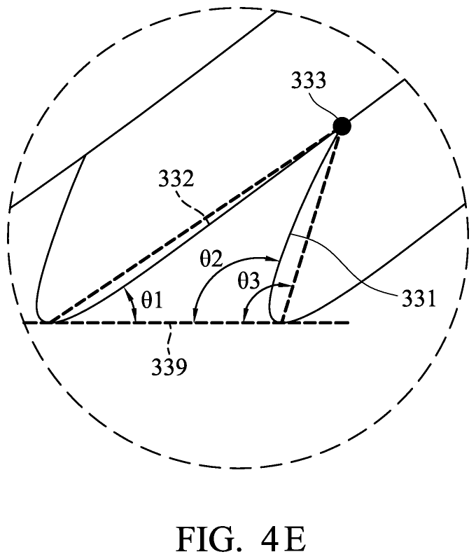

With reference to FIG. 4A, in one embodiment, a disclination line structure 300 is formed between the first sub-pixel area R1 and the second sub-pixel area R2. The disclination line structure 300 comprises a first disclination line area 311 and two second disclination line areas 312. The first disclination line area 311 is located between the two second disclination line areas 312. The width W1 of one of the second disclination line areas 312 away from an end of the first disclination line area 311 perpendicular to an extending direction of the common electrode 40 is greater than the minimum width W2 of the first disclination line area 311 perpendicular to the extending direction of the common electrode 40. With reference to FIG. 4C, in this embodiment, the first extending portion 120 and the second extending portion 220 are retracted in the second disclination line areas 312. The first extending portion 120 is retracted upwardly, and the second extending portion 220 is retracted downwardly. Therefore, the width of the second disclination line areas 312 away from an end of the first disclination line area 311 perpendicular to an extending direction of the common electrode 40 is greater than the minimum width of the first disclination line area 311 perpendicular to the extending direction of the common electrode 40.

With reference to FIG. 4D, in one embodiment, the tilt angles of the first extending portions 120 are gradually changed. For example, the tilt angle θ3 of the first extending portions 120 adjacent to the vertical axis of the first main portion 110 is 45 degrees, and the tilt angle θ4 of the first extending portions 120 away from the vertical axis of the first main portion 110 is greater than 45 degrees. Therefore, the width of the second disclination line areas 312 away from an end of the first disclination line area 311 perpendicular to an extending direction of the common electrode 40 is greater than the minimum width of the first disclination line area 311 perpendicular to the extending direction of the common electrode 40.

Additionally, by modifying the distance between the first extending portion 120 and the second extending portion 220 and the data lines adjacent thereto, the width of one of the second disclination line areas 312 away from an end of the first disclination line area 311 perpendicular to an extending direction of the common electrode 40 is greater than the minimum width of the first disclination line area 311 perpendicular to the extending direction of the common electrode 40. By modifying the cell gap and the pre-tilt angle, the width of one of the second disclination line areas 312 away from an end of the first disclination line area 311 perpendicular to an extending direction of the common electrode 40 is greater than the minimum width of the first disclination line area 311 perpendicular to the extending direction of the common electrode 40. Particularly, the common electrode 40 between the first sub-pixel area R1 and the second sub-pixel area R2 is parallel to the scan lines. Therefore, the width of the second disclination line areas 312 away from an end of the first disclination line area 311 perpendicular to an extending direction of the scan line is greater than the minimum width of the first disclination line area 311 perpendicular to the extending direction of the scan line.

With reference to FIG. 4A, in one embodiment, the disclination line structure 300 comprises a disclination line main portion 320 and a plurality of top indentations 330 and bottom indentations 340 respectively located at two sides of the disclination line main portion 320. A portion of the top indentations 330 are staggered with the bottom indentations 340 corresponding thereto. In one embodiment, the top indentations 330 and the bottom indentations 340 are hook-shaped. In more detail, the first disclination line area 311 comprises at least four top indentations 330 located on both sides of the vertical axis of the first main portion (two top indentations on right side and two top indentations on left side) and at least four bottom indentations 340 located on both sides of the vertical axis of the second main portion (two bottom indentations on the right side and two bottom indentations on the left side).

With reference to FIGS. 4B and 4E, a virtual line segment 339 is defined as the location where one of the top indentations 330 connect to the disclination line main portion 320. The virtual line segment 339 is parallel to the common electrode 40. One of the top indentations 330 comprises a first disclination line side 331 and a second disclination line side 332. The first disclination line side 331 is relatively adjacent to the center of the disclination line main portion 320. The second disclination line side 332 is relatively away from the center of the disclination line main portion 320. An included angle θ2 between the first disclination line side 331 and the virtual line segment 339 is greater than an included angle θ1 between the second disclination line side 332 and the virtual line segment 339, and the first included angle θ1 and the second included angle θ2 are inside the top indentation. In another embodiment, first disclination line side 331 connects the second disclination line side 332 at a turning point 333, a connection line is defined as between the turning point 333 and an end of the first disclination line side 331 away from the turning point 333, and an included angle θ3 between the connection line and the virtual line segment 339 is greater than an included angle θ1 between the second disclination line side 332 and the virtual line segment 339, the included angle θ3 is obtuse angle.

With reference to FIG. 4E, in one embodiment, the first disclination line side 331 connects the second disclination line side 332 at a turning point 333, and an area of the top indentation 330 is smaller than a triangle area enclosed by two ends of the virtual line segment 339 and the turning point 333 (as presented in dot lines). In one embodiment, the first disclination line side 331 is curved.

The disclination line structure 300 decreases retention time. The top indentations 330 and the bottom indentations 340 can be defined by the binarization image of the disclination line. In one embodiment, the included angle θ1 of each of the top indentations 330 away from the center of the disclination line main portion is smaller than the included angle θ2 adjacent to the center of the disclination line main portion. In one embodiment, parts of the top indentations 330 are staggered with the corresponding bottom indentations 340. Additionally, the top indentations 330 away from the center of the disclination line main portion are staggered with the corresponding bottom indentations 340, and the visual angle is made uniform.

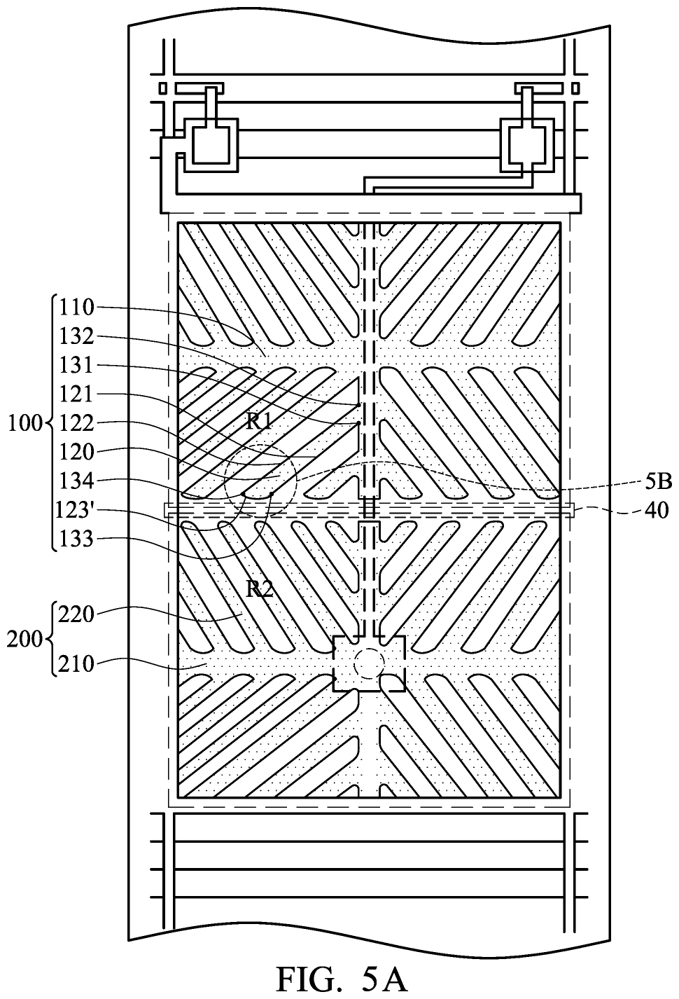

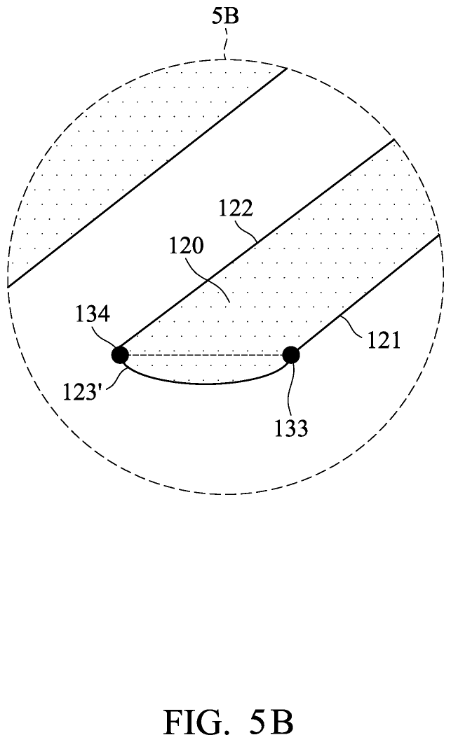

With reference to FIGS. 5A and 5B, in another embodiment, the first electrode 100 comprises a first main portion 110 and a plurality of first extending portions 120. The first extending portions 120 are connected to the first main portion 110. At least one of the first extending portions 120 comprises a first side 121, a second side 122, and a curved side 123′. The first side 121 is parallel to the second side 122. The curved side 123′ connects the first side 121 and the second side 122. The first side 121 connects to the first main portion 110 at a first end point 131. The second side 122 connects to the first main portion 110 at a second end point 132. The curved side 123′ connects to the first side 121 at a third end point 133. The curved side 123′ connects to the second side 122 at a fourth end point 134. The area of the first extending portion 120 is greater than a quadrilateral area enclosed by the first end point 131, the second end point 132, the third end point 133, and the fourth end point 134.

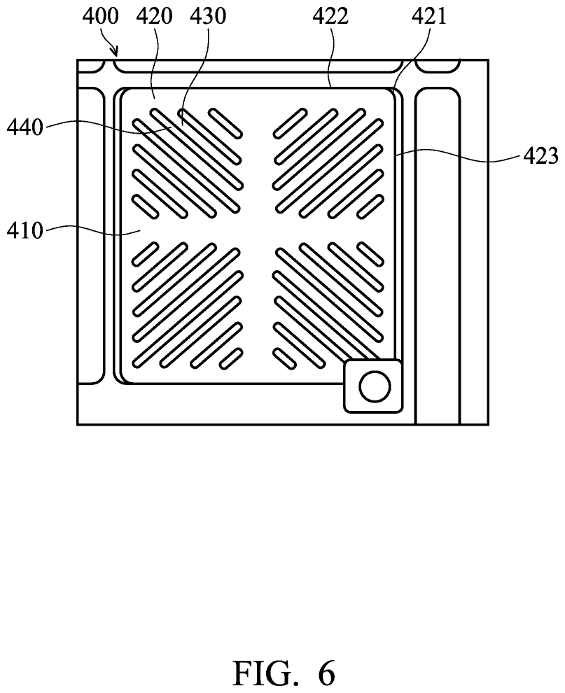

The embodiment can also be utilized in a close-type indium tin oxide (ITO) electrode display device. In this embodiment, a common electrode, an insulation layer and a first electrode are sequentially disposed on the first substrate. An opposite electrode is disposed on the second substrate. With reference to FIG. 6, the first electrode 400 comprises a cross-shaped main portion 410, a peripheral portion 420 and a plurality of extending portions 430 connected to the main portion 410 and the peripheral portion 420. A gap 440 is formed between the extending portions 430. The peripheral portion 420 comprises at least one curved side 421. In one embodiment, the peripheral portion 420 comprises a fifth side 422 and a sixth side 423. The fifth side 422 is parallel to the horizontal axis of the cross-shaped main portion 410. The sixth side 423 is parallel to the vertical axis of the cross-shaped main portion 410. The curved side 421 connects the fifth side 422 at a fifth tangent point, and the curved side 421 connects the sixth side 423 at a sixth tangent point.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name.

While the disclosure has been described by way of example and in terms of the preferred embodiments, it is to be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A display device, comprising:
a first substrate;
a second substrate;
a liquid-crystal layer disposed between the first substrate and the second substrate;
a first electrode disposed on the first substrate, wherein the first electrode comprises:
a first main portion that is a cross-shaped electrode with a first horizontal axis and a first vertical axis;
a first peripheral portion parallel with the first vertical axis of the first main portion; and
a plurality of first extending portions, wherein part of the plurality of first extending portions extend into the first peripheral portion, and other part of the plurality of first extending portions do not extend into the first peripheral portion; and
a second electrode separated from the first electrode, wherein the second electrode comprises:
a second main portion that is a cross-shaped electrode with a second horizontal axis and a second vertical axis;
a second peripheral portion parallel with the second vertical axis of the second main portion; and
a plurality of second extending portions, wherein part of the plurality of second extending portions extend into the second peripheral portion, and other part of the plurality of second extending portions do not extend into the second peripheral portion,
wherein the part of the plurality of first extending portions that extend into the first peripheral portion are connected to each other via a first vertically-extending portion that extends parallel with the first vertical axis, and the other part of the plurality of first extending portions that do not extend into the first peripheral portion are separated from each other,
wherein the part of the plurality of second extending portions that extend into the second peripheral portion are connected to each other via a second vertically-extending portion that extends parallel with the second vertical axis, and the other part of the plurality of second extending portions that do not extend into the second peripheral portion are separated from each other,
wherein in a direction that is parallel with the first vertical axis, a shortest distance between the first vertically-extending portion and the second vertically-extending portion is greater than a shortest distance between the other part of the plurality of first extending portions that do not extend into the first peripheral portion and the other part of the plurality of second extending portions that do not extend into the second peripheral portion.

2. The display device as claimed in claim 1, wherein the first vertically-extending portion has a first curved edge, the second vertically-extending portion has a second curved edge, and the first curved edge and the second curved edge face each other.

3. The display device as claimed in claim 1, wherein a horizontal width of the first vertically-extending portion is different from a horizontal width of any of the plurality of first extending portions that extend into the first peripheral portion.

4. The display device as claimed in claim 1, wherein a horizontal width of the first vertically-extending portion is greater than a horizontal width of one of the plurality of first extending portions that extend into the first peripheral portion.

5. The display device as claimed in claim 1, wherein a horizontal width of one of the other part of the plurality of first extending portions that is relatively farther away from the first main portion is shorter than a horizontal width of another one of the other part of the plurality of first extending portions that is relatively close to the first main portion.

6. The display device as claimed in claim 1, wherein one of the other part of the plurality of first extending portions that do not extend into the first peripheral portion has a first round corner and a second round corner.

7. The display device as claimed in claim 6, wherein the first round corner is relatively close to the first main portion, the second round corner is relatively farther away from the first main portion, and a first curvature radius of the first round corner is different from a second curvature radius of the second round corner.

8. The display device as claimed in claim 7, wherein the second curvature radius is smaller than the first curvature radius.

9. The display device as claimed in claim 7, wherein the first curvature radius of the first round corner is smaller than 10 μm.

10. The display device as claimed in claim 7, wherein the first curvature radius of the first round corner is smaller than 5 μm.

11. The display device as claimed in claim 1, wherein a number of the other part of the plurality of first extending portions that do not extend into the first peripheral portion is same as a number of the other part of the plurality of second extending portions that do not extend into the second peripheral portion.

12. The display device as claimed in claim 1, wherein at least part of the other part of the plurality of first extending portions that do not extend into the first peripheral portion and at least part of the other part of the plurality of second extending portions that do not extend into the second peripheral portion are staggered.

13. The display device as claimed in claim 1, wherein one of the part of the plurality of first extending portions that extend into the first peripheral portion tilts at a first angle, one of the other part of the plurality of first extending portions that do not extend into the first peripheral portion tilts at a second angle, and the first angle is different from the second angle.

14. The display device as claimed in claim 13, wherein the first angle is smaller than the second angle.

15. The display device as claimed in claim 13, wherein the second angle is greater than 45 degrees.

16. The display device as claimed in claim 1, further comprising a plurality of data lines extending along the first vertical axis.

17. The display device as claimed in claim 16, further comprising a plurality of scan lines extending along a direction that is perpendicular to the first vertical axis.

18. The display device as claimed in claim 17, wherein two of the plurality of data lines and two of the plurality of scan lines and two of the plurality of data lines define a pixel area.

19. The display device as claimed in claim 18, further comprising a first sub-pixel area and a second sub-pixel area, wherein the first sub-pixel area and the second sub-pixel area are located in the pixel area, the first electrode is located in the first sub-pixel area, and the second electrode is located in the second sub-pixel area.

20. The display device as claimed in claim 19, further comprising a disclination line structure between the first sub-pixel area and the second sub-pixel area, wherein the disclination line structure comprises a disclination line main portion and a plurality of top indentations.
